(19) United States
(12) Patent Application Publication
(10) Pub. No.: US 2016/0024826 A1
(43) Pub. Date: Jan. 28, 2016

(54) A Carriage

(71) Applicant: CENTOR DESIGN PTY LTD, Brisbane, Queensland (AU)

(72) Inventor: Michael Smith, Hamilton, Queensland (AU)

(21) Appl. No.: 14/772,825

(22) PCT Filed: Mar. 10, 2014
(86) PCT No.: PCT/AU2014/000232

§ 371 Date: Sep. 4, 2015

(30) Foreign Application Priority Data
Mar. 11, 2013 (AU) 2013900828

(51) Int. Cl. E05D 15/06

(52) U.S. Cl. CPC E05D 15/0639; E05D 15/0604; E05D 15/0652

(57) ABSTRACT

A carriage for a folding door or window, the carriage comprising a body, a movement portion adapted to facilitate movement of the carriage relative to a track, and at least a pair of hinge bolts adapted for connection to the body.

### TECHNICAL FIELD

The present invention relates to a carriage. In particular, the present invention relates to a carriage for a folding door or window having two or more panels. Still more specifically, the present invention relates to a carriage for a folding door or window having two or more equally sized panels.

### BACKGROUND ART

Folding doors and windows are a popular building choice due to their ability to provide clear, unimpeded openings in a wall. A typical folding door or window comprises a plurality of hinged panels suspended from one or more carriages which travel along an overhead track. A carriage and a hinge may be combined to form a carrier hinge in which the hinge pin serves to suspend the hinge (and affixed panels) from the carriage, as shown in U.S. Pat. No. 6,618,900.

The panels may open by folding, in concertina fashion, to one side of the opening. Alternatively, particularly for wide openings, the panels may be formed as two hinged sets which fold to opposite sides of the opening. In both cases, the panels fold open to an orientation in which they are juxtaposed parallel to each other, 90° to the plane of the opening, to minimise the width of the opening they occupy.

Conventional carriages are adapted to be associated with a single hinge bolt. The hinge bolt typically has a pair of hinge leaves mounted thereon. In this situation one of the pair of hinge leaves will be attached to a first panel, while the second hinge leaf will be attached to a second panel adjacent to the first. This arrangement is popular as it allows a hinge having a single hinge bolt to be connected to a pair of adjacent panels, thereby minimising the material used in the hinge. This in turn reduces the cost of producing the hinge.

The other significant benefit of this arrangement is that the size of the carrier hinge is kept relatively compact so that the carrier hinge does not prevent the panels from folding into abutment, or at least close proximity to one another.

In some conventional carrier hinges, the hinge bolt may be provided with an adjustment mechanism so that the position of the hinge bolt relative to the carriage may be adjusted. This adjustment mechanism allows the vertical position of the panels to be adjusted so as to maintain the panels at the same height as one another.

While effective, this arrangement of conventional carrier hinges has the disadvantage that, because the carrier hinge is connected to two adjacent panels, an adjustment of the adjustment mechanism changes the vertical height of both of the panels to which the carrier hinge is attached. Thus, it is not possible to adjust the vertical height of individual panels to which the carrier hinge is connected.

In addition, it is desirable in folding door or window assemblies to use panels that are of equal size to one another. This makes the assembly and replacement of door or window panels easier, given that all panels are of a uniform size. However, while some attempts have been made to achieve this, these previous attempts have faced some difficulties. For instance, due to the configuration of conventional carrier hinges, equal sized panels have, in some instances, been positioned out of alignment (i.e. offset from one another) when the door or window is in the open position. This is not only detracts from the aesthetic appeal of the assembly, but also makes the assembly difficult to install due to the complexity associated with using offset hinges on the opposite vertical edge of the panels to the carrier hinge.

In light of the foregoing, there would be an advantage if it were possible to provide a carriage (or carrier hinge) for a folding door or window that allowed for the individual adjustment of the vertical position of adjacent panels. In addition, there would be an advantage if it were possible to provide a carrier hinge that allowed all of the panels in a door or window assembly to be of equal size, without increasing the complexity of the installation of the assembly.

It will be clearly understood that, if a prior art publication is referred to herein, this reference does not constitute an admission that the publication forms part of the common general knowledge in the art in Australia or in any other country.

### SUMMARY OF INVENTION

The present invention is directed to a carriage which may at least partially overcome at least one of the abovementioned disadvantages or provide the consumer with a useful or commercial choice.

In one aspect, the invention resides broadly in a carriage for a folding door or window, the carriage comprising a body, a movement portion adapted to facilitate movement of the carriage relative to a track, and at least a pair of hinge bolts adapted for connection to the body.

In a preferred embodiment of the invention, the carriage is adapted to be associated with a track positioned at the head of a door or window opening, although it is envisaged that the carriage could alternatively be associated with a track positioned at the sill of a door or window opening. The track may be of any suitable form, and the exact nature of the track is not critical to the present invention.

The movement portion may be of any suitable form. For instance, the movement portion may be adapted to allow the carriage to slide, pivot, or otherwise move relative to the track. Typically, however, the movement portion may be adapted to facilitate sliding movement of the carriage relative to the track. This may be achieved by, for instance, providing the movement portion with one or more movement members. Any suitable movement member that facilitates a sliding movement may be used, such as one or more rollers, endless tracks, slides or the like, or any suitable combination thereof.

Any suitable number of movement members may be provided. However, in a preferred embodiment of the invention, the carriage may be provided with a first movement member at a first end thereof, and a second movement member at an opposed second end thereof. In this embodiment of the invention, the movement members may preferably comprise rollers or wheels.

By providing movement members at opposed ends of the carriage, the carriage may be substantially balanced, so that movement in both directions along the track may be achieved using substantially the same amount of energy or force.

The construction of the movement portion may be of a conventional nature, and no specific discussion of the type and construction of the movement portion is necessary.

Preferably, the movement portion may be adapted to be maintained in contact with a support surface portion of the track. In this way, the carriage may be effectively suspended from the track. By suspending the carriage from the track under the effect of gravity in this manner, the carriage is effectively precluded from unwanted vertical movement.

It is anticipated that, in some embodiments, the support surface may be substantially planar. Alternatively, the support surface may be of any suitable shape to improve the ease with which the carriage moves relative to the track. For instance, the support surface may be U- or V-shaped, or may be provided with a channel or the like in which the movement portion is adapted to be received.

In some embodiments, the support surface may be defined by one or more boundary members. The boundary members may be of any suitable form, such as, but not limited to, one or more walls. It is envisaged that the one or more walls will prevent, or at least reduce, the lateral movement of the carriage within the track.

In a preferred embodiment of the invention, the movement portion may further include one or more guides. The purpose of the guides is twofold: to improve the ease of movement of the carriage relative to the track, and to assist in maintaining the carriage in a substantially consistent orientation within the track. Typically, it will be desired to ensure that the carriage remains substantially vertical at all times, as variations from this orientation can lead to window or door panels being out of alignment, which is not only aesthetically displeasing but also means that the door or window may not open or shut properly.

The guides may be of any suitable form. For instance, the guides may include one or more rollers, wheels, slides or the like (or any combination thereof). In a preferred embodiment, the guides may be located in close proximity to, or in abutment with, the boundary members of the track. This further reduces the possibility of the lateral movement of the carriage within the track.

The body of the carriage may be of any suitable form. In some embodiments of the invention, the body comprises a unitary structure to which the movement portion (and guides, if present) is attached. Alternatively, the body may be fabricated in two or more portions adapted for fixed or removable attachment thereto. The movement portion (and guides, if present) may be connected to any suitable part of the body.

In one particular embodiment of the invention, the body may be formed in two portions adapted for attachment to one another. In this embodiment, the movement portion may be attached to a first portion of the body, while the guides may be attached to a second portion of the body.

In embodiments of the invention in which the body comprises two or more portions, the position of the portions relative to one another (and, in particular, the vertical position) may be capable of adjustment.

The two or more hinge bolts may be adapted for connection to the body at any suitable location and using any suitable technique. Preferably, however, the two or more hinge bolts connect to the body in a central region of the body. In this way, the weight of the panels suspended from the carriage may be distributed approximately evenly in the carriage. This means that moving the carriage along the track in either direction will require approximately the same amount of force or energy. It also means that any wear to the movement portion over time should occur in a substantially even manner.

In some embodiments of the invention, the hinge bolts may connect to the carriage using a screw-threaded engagement. Alternatively, the hinge bolts may connect to the carriage via fastening means (such as bolts, screws, nails, rivets or the like). Still further, the hinge bolts may be fixedly connected to the carriage by welding (or similar processes), adhesives and so on. In yet another embodiment, the hinge bolts may be formed integrally with the carriage.

Preferably, the hinge bolts may be adapted to connect with the carrier by being at least partially inserted into screw-threaded bores in the carrier. The carrier may comprise any suitable number of screw-threaded bores, although it is preferred that the carrier is provided with one screw-threaded bore for each hinge bolt. Preferably, the hinge bolts are provided with a screw-threaded portion at an upper end thereof that is adapted for screw-threaded engagement with the bores.

In an alternative embodiment of the invention, the hinge bolt may be at least partly inserted into a lower end of a bore in the carrier, while retaining means may be at least partly inserted into an upper end of the bore. Preferably, the retaining means engages with an upper end of the hinge bolt, so that rotation of the hinge bolt results in a corresponding rotation of the retaining means. Any suitable engagement between the retaining means and the hinge bolt may be provided, although in a preferred embodiment of the invention, a screw-threaded engagement between the hinge bolts and the retaining means is provided.

Preferably, the bore and the retaining means are adapted for screw-threaded engagement with one another. In this embodiment, the hinge bolt may or may not be provided with a screw-threaded portion. Thus, in some embodiments only the retaining means engages with the screw-threaded bore, while in other embodiments both the retaining means and the hinge bolts are in screw-threaded engagement with the bore.

In a preferred embodiment of the invention, an upper end of the retaining means is provided with an enlarged portion. It is envisaged that the diameter of the enlarged portion may be of a greater diameter than the diameter of the bore, such that the enlarged portion is prevented from entering the bore. In this way, the extent of downward movement of the retaining means (and the hinge bolt to which it is attached) is defined by the abutment of the enlarged portion with an upper surface of the carrier.

By limiting the extent of downward movement of the retaining means, the limit of downward movement of the hinge bolt is also defined. This arrangement prevents the hinge bolt from downward movement that would result in the accidental (for instance, by a user making a large adjustment to the hinge) disengagement of the hinge bolt from the bore. In addition, the disengagement of the hinge bolts from the carrier would make the door or window easier to open and gain entry to a structure, meaning that the arrangement also provides additional security against deliberate disengagement of the hinge bolts from the carrier, such as during a burglary.

The retaining means may be of any suitable form. However, in a preferred embodiment of the invention, the retaining means comprise screws. In this embodiment, the enlarged portion of the screw may comprise the head of the screw.

In a preferred embodiment of the invention, the carriage is adapted for the connection of two hinge bolts thereto. Preferably, the hinge bolts are attached to the carriage such that they are in relatively close proximity, in order to minimise the gap between adjacent panels with which the hinge bolts are associated in use.

In a preferred embodiment, a first of the hinge bolts is operatively associated with a first door or window panel, while a second of the hinge bolts is operatively associated with a second door or window panel. Preferably, the first and second panels are positioned adjacent one another in a door or window, and preferably the door or window is a folding door or window. In a particular embodiment of the invention, the door or window panels are, of substantially equal size.

The hinge bolts may be operatively associated with the door or window panels using any suitable technique. However, in a preferred embodiment of the invention, each of the hinge bolts is provided with at least one hinge leaf adapted to allow connection of the hinge bolts to a door or window panel.

Preferably, at least one of the hinge bolts is an adjustable hinge bolt, although more preferably both of the hinge bolts are adjustable hinge bolts. In this embodiment of the invention, the adjustable hinge bolt may be adjusted so as to alter the position of the hinge leaf (and the door or window panel to which it is attached) relative to the carriage. Adjustment of the hinge bolt may be required if, over time, the position (specifically, the vertical position) of the panels change and become uneven.

By providing a pair of adjustable hinge bolts, each of which is operatively associated with a separate door or window panel, the position of individual panels may be adjusted independently of adjacent panels. This provides a user with an improved ability to ensure that all of the panels in a folding window or door are correctly positioned which not only improves the functioning of the door or window, but also improves the aesthetic appeal of the door or window.

In a preferred embodiment of the invention, each of the door or window panels are of equal size.

In another aspect, the invention resides broadly in a carrier hinge for a folding door or window assembly, the carrier hinge including a carriage having a pair of hinge bolts connected thereto, wherein each of the pair of hinge bolts is provided with at least one hinge leaf, and wherein the at least one hinge leaf of a first of the pair of hinge bolts is adapted for attachment to a first door or window panel, while the at least one hinge leaf of a second of the pair of hinge bolts is adapted for attachment to a second door or window panel.

Preferably, the carriage is associated with a track located at the head or sill of a door or window opening. In a preferred embodiment, however, the track is located at the head of the door or window opening, so that the carrier hinge is supported by the track and effectively hangs from the track.

In a preferred embodiment of the invention, the carriage is provided with a movement portion that facilitates movement of the carriage relative to the track. The movement portion may be of any suitable form. For instance, the movement portion may be adapted to allow the carriage to slide, pivot, or otherwise move relative to the track. Typically, however, the movement portion may be adapted to facilitate sliding movement of the carriage relative to the track. This may be achieved by, for instance, providing the movement portion with one or more movement members. Any suitable movement member that facilitates a sliding movement may be used, such as one or more rollers, endless tracks, slides or the like, or any suitable combination thereof.

Any suitable size and configuration of the hinge bolts may be used. However, it will be understood that the size and configuration of the hinge bolts will vary depending on the location and duty of the door or window (e.g. indoor, outdoor, climatic conditions etc.), the size, material and weight of the panels to be attached to the carrier hinge and so on.

It will be understood that, in a door or window assembly in which three or more door or window panels are present, multiple carrier hinges may be provided. Preferably, each of the door or window panels in such a door or window assembly is of substantially equal size.

In a door or window assembly in which carrier hinge of the present invention is used, it is envisaged that, when the assembly is in the open condition, the vertical edges of the panels to which the carrier hinges are attached may be substantially in alignment with the track. In the open condition, it is also envisaged that the vertical edges of the panels located remote from the carrier hinges may be in substantial alignment with one another. In this way, an assembly in which all of the panels are of equal size, and are uniformly aligned with one another in the open condition may be achieved. Not only does this provide an aesthetically pleasing result, but it also makes the assembly both relatively simple to install, and relatively simple to replace panels for repair or to replace panes of glass, and to locate hinges.

Preferably, the vertical edges, of the panels located remote from the track when the assembly is in the open condition are provided with hinges. Any suitable hinges may be used (such as butt hinges), although in a preferred embodiment the hinges comprise so-called “invisible” hinges. A skilled addressee will understand what is meant by an invisible hinge, and no specific discussion of this is necessary.

It will also be understood that the use of offset hinges will be eliminated by the present invention, as the use of offset hinges will not result in a door or window assembly in which the panels are aligned with one another in the open condition.

Any of the features described herein can be combined in any combination with any one or more of the other features described herein within the scope of the invention.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1A illustrates a front view of a carrier hinge according to an embodiment of the present invention.

FIG. 1B illustrates a side view of a carrier hinge according to an embodiment of the present invention.

FIG. 1C illustrates a perspective view of a carrier hinge according to an embodiment of the present invention.

FIG. 2 illustrates a plan view from above of a door assembly including a carrier hinge according to an embodiment of the present invention.

FIG. 3A illustrates a front view of a door assembly including a carrier hinge according town embodiment of the present invention.

FIG. 3B illustrates a rear view of a door assembly including a carrier hinge according to an embodiment of the present invention.

FIG. 4 illustrates a front view of a door assembly including a carrier hinge according to an embodiment of the present invention.

### DESCRIPTION OF EMBODIMENTS

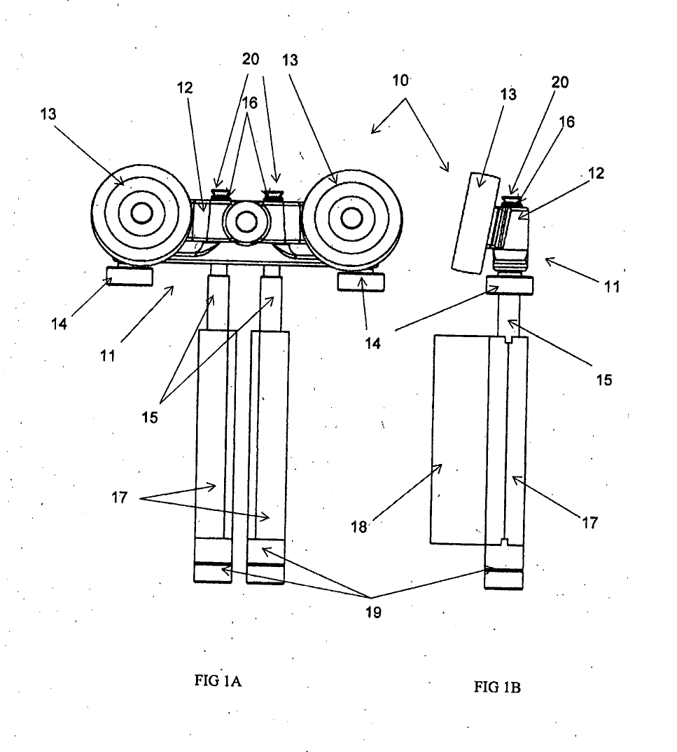

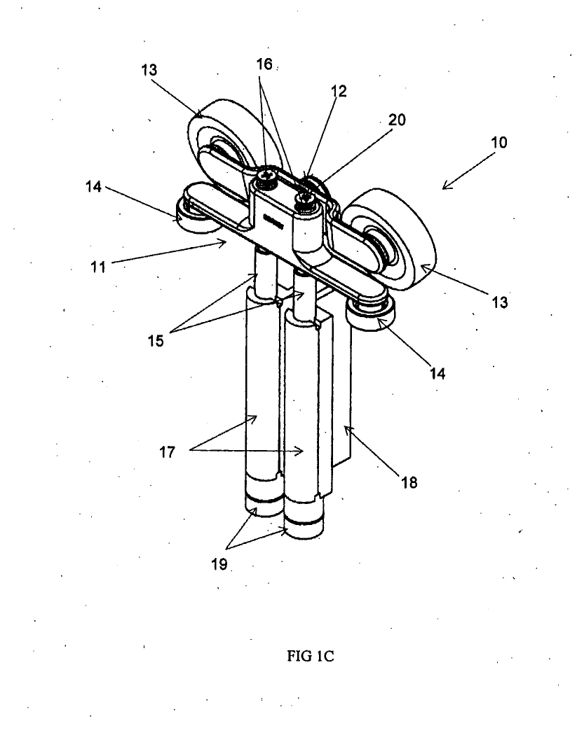

In FIGS. 1A, 1B and 1C there is illustrated a front view of a carrier hinge 10 according to an embodiment of the present invention, a side view of a carrier hinge 10 according to an embodiment of the present invention, and a perspective view of a carrier hinge 10 according to an embodiment of the present invention, respectively. The carrier hinge 10 comprises a carriage 11 that includes a body 12, a movement portion comprising movement members in the form of a pair of rollers 13 located at opposite ends of the body 12 and a pair of guides 14. The rollers 13 are adapted to abut a lower surface of a track (not shown) while the guides 14′ are adapted to abut (or be held in close proximity to) a side wall of a track (not shown). In this way, the carriage 11 is precluded from excessive vertical and lateral movement within the track (not shown).

The carriage 11 is adapted for the connection of a pair of hinge bolts 15 thereto. The hinge bolts 15 are attached to the body 12 of the carriage 11 via a screw-threaded engagement with a bore (obscured). Screws 16 are inserted into the upper end of the bore (obscured), and engage with upper ends of the hinge bolt 15 in a screw-threaded engagement.

As the height of the hinge bolt 15 is adjusted downwards relative to the carriage 11, the screws 16 also move further into the bore (obscured). However, the limit of downward movement of the screws 16 (and therefore the hinge bolts 15 to which they are attached) relative to the carriage 11 is reached when the head 20 of the screw 16 abuts an upper surface of the carriage 11, the diameter of the head 20 of the screw 16 being larger than the diameter of the bore (obscured).

A hinge knuckle 17 is provided on each of the hinge bolts 15. The hinge knuckle is provided with a hinge leaf 18 which is adapted for connection to a window or door panel (not shown). The hinge leaves 18 are adapted for connection to adjacent panels (not shown).

Each hinge bolt 15 is provided with an adjustment portion 19 at a lower end thereof. The exact nature of the adjustment portion 19 is not critical, although typically activation of the adjustment portion 19 allows for the rotation of the hinge bolt 15 relative to the hinge knuckle 17. Rotation of the hinge bolt 15 either screws the hinge bolt 15 further into or out of the bore (obscured), meaning that the vertical position of the panel (not shown) relative to the carriage 11 may be adjusted.

By providing an adjustable hinge bolt 15 attached to each adjacent panel, the vertical position of the panel (not shown) relative to the carriage 11 may be adjusted independently of an adjacent panel attached to the carrier via the second hinge bolt 15. This ensures an aesthetically pleasing result can be achieved, by the installer even if the hinge attachment position is not identical, and may also provide improved functioning of the door or window assembly.

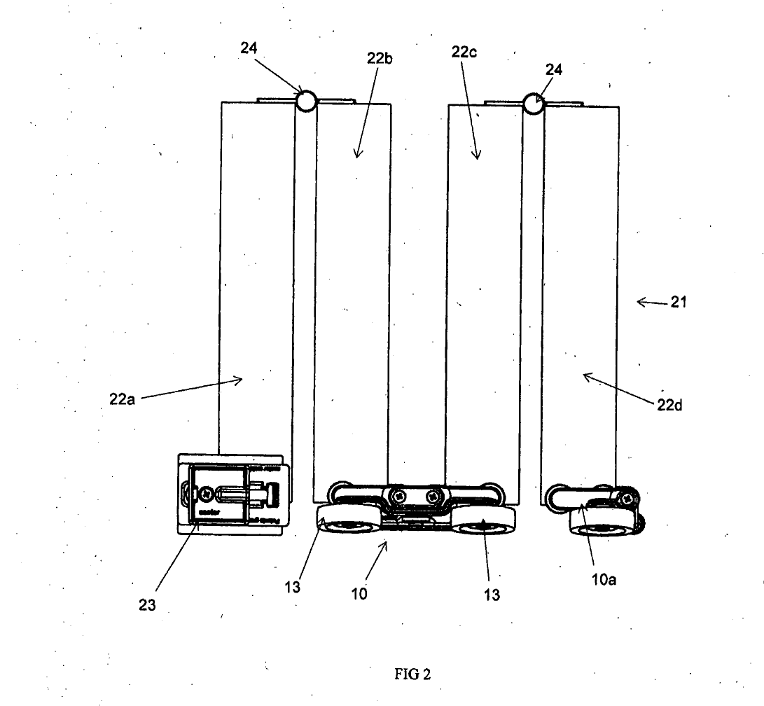

In FIG. 2 there is shown a plan view from above of a door assembly 21 including a carrier hinge 10 according to an embodiment of the present invention. The door assembly 21 is for a folding door comprising 4 door panels 22a, 22b, 22c, 22d, all of which are of substantially equal size. In the carrier hinge 10, a first adjustable hinge bolt (obscured) is operatively attached to panel 22b while a second adjustable hinge bolt (obscured) is operatively attached to panel 22c. In this way, the vertical position of panels 22b and 22c can be adjusted independently of one another.

A second carrier hinge 10a is connected to panel 22d. However, this carrier hinge 10a only includes a single hinge bolt (obscured) that allows for adjustment of panel 22d only. The reason that panel 22d is not connected to another panel but a dual hanger bolt carrier hinge (such as carrier hinge 10) is that panel 22d may be the panel that abuts the opposite door jamb (or a corresponding door assembly extending from the opposite door jamb) when the door assembly 21 is closed.

Panel 22a is located adjacent a door jamb (not shown). The panel 22a is attached to a pivot hinge 23 which is in turn attached either to the door jamb (not shown) or the head of the door opening (not shown). The pivot hinge 23 allows the panel 22a to pivot between the open condition shown in FIG. 2, and a closed condition wherein the panel 22a is pivoted approximately 90° in a clockwise direction. However, the pivot hinge 23 prevents lateral movement of the end of the panel 22a to which it is attached.

Panels 22a and 22b, and 22c and 22d, are connected to one another via butt hinges 24. The butt hinges 24 are provided on the ends of the panels 22a, 22b, 22c, 22d that are remote from the carrier hinge 10 when the door assembly 21 is in the open condition (as shown in FIG. 2). In this way, when in the open condition, the carrier hinge 10 is aligned with the track (not shown), while the butt hinges 24, are positioned out of alignment with the track (not shown) but substantially in alignment with one another.

As previously mentioned, the carrier hinge 10 is aligned with (and engaged with) the track (not shown). The rollers 13 are adapted to roll along the track (not shown) in a lateral direction. Thus, the carrier hinge 10 remains in alignment with the pivot hinge 23 at all times, while the butt hinges 24 move between the open position (shown in FIG. 2) and a closed position in which the butt hinges 24 are in substantial alignment with the pivot hinge 23.

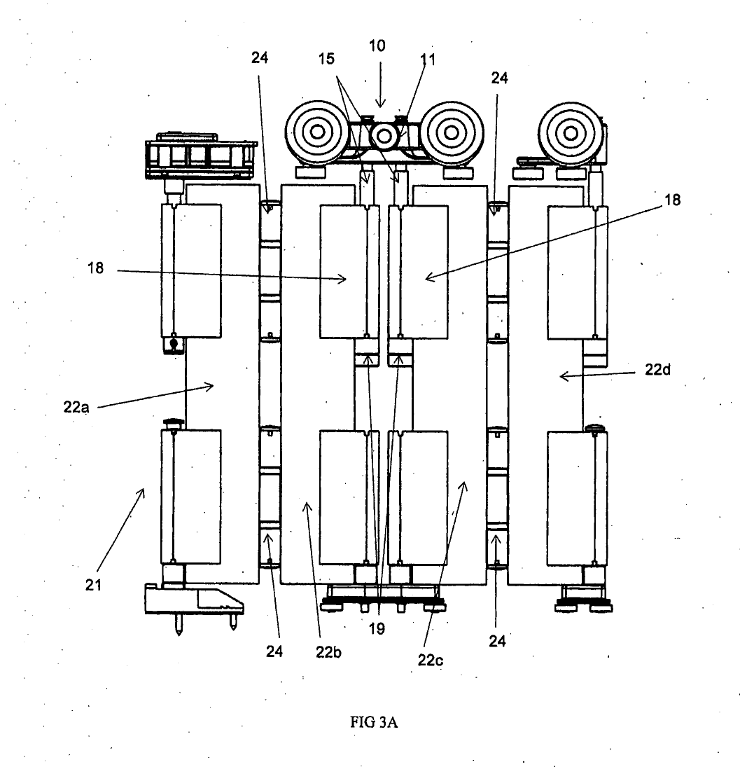

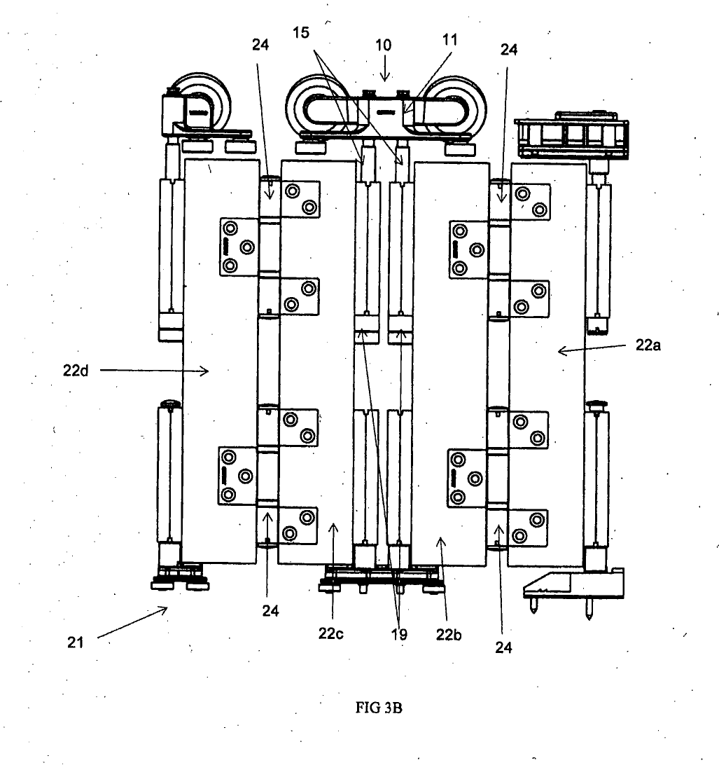

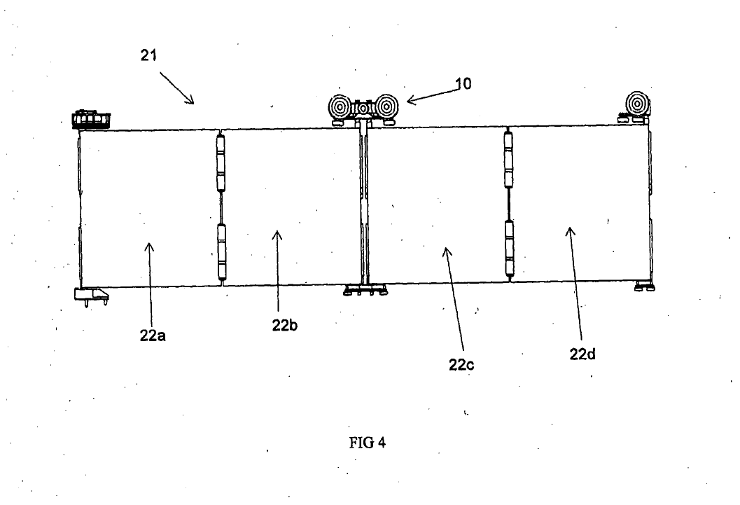

FIGS. 3A and 3B illustrate front and rear views, respectively, of a door assembly 21 including a carrier hinge 10 according to an embodiment of the present invention. The door assembly 21 shown in these Figures is in the open condition, and it may be seen that a first pair of butt hinges 24 is connected to panels 22a and 22b, and a second pair of butt hinges 24 is connected to panels 22c and 22d.

In these figures panels 22a, 22b, 22c and 22d may be seen with the carrier hinge 10 attached to panels 22b and 22c. The carrier hinge 10 comprises a pair of hinge bolts 15 that engage with bores (obscured) in the carriage 11 via a screw-threaded engagement. Each carrier hinge 10 includes a hinge leaf 18 that is adapted for attachment to one panel only.

The hinge bolts 15 are provided with an adjustment portion 19. When the adjustment portion 19 is activated, the hinge bolt 15 is freed for rotation relative to the hinge leaf 18 so that the hinge bolt 15 is screwed further into, or out of, the screw-threaded engagement with the bore (obscured). In this way, the vertical positioning of the hinge bolt 15 (and through it, the hinge leaf 18 and panel 22b; 22c to which it is attached) may be adjusted relative to the carriage 11. The fact that the carrier hinge 10 comprises two hinge bolts 15 means that the vertical position of each panel 22b, 22c relative to the carriage 11 may be adjusted independently of one another.

In FIG. 4 there is shown a front view of a door assembly 21 including a carrier hinge 10 according to an embodiment of the present invention. The assembly 21 shown in FIG. 4 is virtually identical to that shown in FIGS. 3A and 3B, with the exception that the assembly 21 is shown in the closed position. In the closed position, the panels 22a, 22b, 22c, 22d are positioned in substantially the same alignment.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A carriage for a folding door or window, the carriage comprising a body, a movement portion adapted to facilitate movement of the carriage relative to a track, and at least a pair of hinge bolts adapted for connection to the body, wherein each of the adjustable hinge bolts is operatively associated with a separate window or door panel such that the vertical orientation of each panel is adjustable independently of adjacent panels.

2. The A carriage according to claim 1 wherein the movement portion comprises one or more movement member adapted to facilitate sliding movement of the carriage relative to the track.

3. The carriage according to claim 1 wherein the movement portion further comprises one or more guides.

4. The carriage according to claim 1 wherein the movement portion is adapted to be maintained in contact with a support surface portion of the track.

5. The carriage according to claim 1 wherein the hinge bolts are connected to the body using a screw-threaded engagement.

6. The carriage according to claim 1 wherein a first of the pair of hinge bolts is operatively associated with a first window or door panel, and a second of the pair of hinge bolts is associated with a second window or door panel.

7. The carriage according to claim 1 wherein each hinge bolts is provided with at least one hinge leaf adapted to allow connection of the hinge bolts to the respective window or door panels.

8. The carriage according to claim 7 hinge bolts may be adjusted so as to alter the position of the window or door panel relative to the carriage.

9. The carriage according to claim 1 wherein the window or door panels are of equal size.

10. A carrier hinge for a folding door or window assembly, the carrier hinge including a carriage having a pair of adjustable hinge bolts connected thereto, wherein each of the pair of hinge bolts is provided with at least one hinge leaf, and wherein the at least one hinge leaf of a first of the pair of hinge bolts is adapted for attachment to, and is operatively associated with, a second door or window panel, such that the vertical position of each of the first and second door or window panels is adjustable independently of the other of the first and second door or window panels.

11. The carrier hinge according to claim 10 wherein the carriage is provided with a movement portion adapted to facilitate movement of the carriage relatice to the track.

12. The carrier hinge according to claim 11 wherein the movement portion comprises one or more movement members adapted to facilitate sliding movement of the carriage relative to the track.

13. The carrier hinge according to claim 12 wherein the Door or window panels are of equal size.

14. (canceled)
